(19) United States
(12) Patent Application Publication
(10) Pub. No.: US 2009/0170693 A1
(43) Pub. Date: Jul. 2, 2009

(54) Catalyst Included in Hollow Porous Capsule and Method for Producing the Same

(76) Inventor: Shigeru Ikeda, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/085,678

(22) PCT Filed: May 31, 2006
(86) PCT No.: PCT/JP2006/310877

§ 371 Date: Aug. 8, 2008

(30) Foreign Application Priority Data
Nov. 30, 2005 (JP) 2005-346683

(51) Int. Cl. B01J 31/02; B01J 23/58; B01J 21/08; B01J 21/18

(52) U.S. Cl. 502/158; 502/328; 502/242; 502/182

(57) ABSTRACT

An object of the present invention is to provide a catalyst which can exert a catalytic function for a long period without decreasing catalytic activity, and a photocatalyst which can exert a photocatalytic function for a long period while preventing deterioration of the organic binder without reducing original decomposition and sterilization functions of the photocatalyst. In light of the object, a carbon-containing layer is formed on the core portion so that it is coated by a carbon-containing layer, subsequently the porous layer is formed on the carbon-containing layer so that it is coated by the porous layer, and a hollow layer is formed by removing the carbon-containing layer.

### TECHNICAL FILED

The present invention relates to a catalyst which decreases activation energy thereby promoting the reaction, and a method for producing the same, and particularly to a photocatalyst which can decompose toxic substances in the air, odors or dirts by irradiating with ultraviolet light.

### BACKGROUND ART

It has now become clear that it is possible to exhibit chemical, electronic, optical, magnetic and mechanical characteristics, which are quite different from those in a bulk state, by turning particles into ultrafine particles in the order of several nanometers. It also becomes clear in the field of catalysts that catalyst particles having a diameter around several nanometers exhibit high catalytic activity. However, catalyst particles having a particle diameter of several nanometers have very large surface energy and is insufficient in dispersion stability. Therefore, while the catalyst is used for a long time, catalyst particles are agglomerated and the surface area of a catalyst metal decreases, resulting in decreased catalytic activity.

Therefore, Japanese Unexamined Patent Publication (Kokai) No. 2005-276688 proposes that an agglomeration of catalyst particles is prevented by directly coating a porous substance composed of an inorganic oxide on the surface of nano-particles (Japanese Unexamined Patent Publication (Kokai) No. 2005-276688).

In the case of photocatalyst particles, contamination of the wall surface is usually prevented by mixing a photocatalyst with an organic binder and coating the resultant mixture on the wall surface of the house structure. The photocatalyst has such a specific feature that, when the photocatalyst is irradiated with ultraviolet light, not only pollutants adhered on the wall surface but also the organic binder for fixation existing around the photocatalyst are decomposed. Therefore, Japanese Unexamined Patent Publication (Kokai) No. 2001-286728 proposes that the surface of the photocatalyst is directly coated with a porous substance (Japanese Unexamined Patent Publication (Kokai) No. 2001-286728). As described above, when the photocatalyst is coated, since the photocatalyst existing in a core is not directly contacted with the organic binder, deterioration of the organic binder can be prevented.

Japanese Unexamined Patent Publication (Kokai) No. 2003-96399 discloses those in which fine photocatalysts each having a diameter, which is about 1/1,000 or less of that of a capsule, are dispersed in a porous portion and a hollow portion of the capsule made of a hollow porous silica (Japanese Unexamined Patent Publication (Kokai) No. 2003-96399). Fine photocatalyst particles are dispersed in the hollow portion and the porous portion of the capsule, and the organic binder does not drastically penetrate into the porous portion of the capsule, and thus the active site of the photocatalyst does not decrease and deterioration of a photocatalytic function can be prevented. Since the organic binder is not drastically contacted with photocatalyst particles, deterioration of the organic binder can be prevented.

### DISCLOSURE OF THE INVENTION

However, in catalyst nano-particles in which a porous substance composed of an inorganic oxide is directly coated on the surface of nano-particles (Japanese Unexamined Patent Publication (Kokai) No. 2005-276688), since catalyst nano-particles are coated with porous ceramics, the entire catalytic action is not reduced. However, there was a problem that since the surface of the catalyst is directly coated, the active site of the catalyst decreases and thus the catalytic function of catalyst particles deteriorates.

In a photocatalyst whose surface is coated with porous ceramics (Japanese Unexamined Patent Publication (Kokai) No. 2001-286728), since the surface of the photocatalyst is directly coated, there arises a problem that the active site of the photocatalyst decreases and thus original pollutant decomposition and sterilization functions of the photocatalyst substance deteriorate.

In a photocatalyst in which fine photocatalyst is dispersed in a porous portion and a hollow portion of a hollow porous silica (Japanese Unexamined Patent Publication (Kokai) No. 2003-96399), since the active site of the photocatalyst does not decrease, original pollutant decomposition and sterilization functions of the photocatalyst substance do not deteriorate. However, there arises a problem that since fine photocatalyst particles are dispersed in pores or a hollow portion of the porous silica, fine photocatalyst particles fall off from pores with a lapse of time and thus a photocatalytic function deteriorates when used for a long period.

The present invention has been made so as to solve the above-described problems, and an object of the present invention is to provide a catalyst which can exert a catalytic function for a long period without decreasing catalytic activity, and a photocatalyst which can exert a photocatalytic function for a long period while preventing deterioration of the organic binder without reducing original decomposition and sterilization functions of photocatalyst.

In light of the object, the present inventors have intensively studied and found that, in a catalyst including a core portion containing the catalyst and a porous layer formed so as to coat the core portion, the active site of the catalyst scarcely decreases and the catalytic function does not deteriorate when a hollow layer is formed between the core portion and the porous layer.

Also, the present inventors have found the followings. Namely, when photocatalyst particles are used as catalyst particles, in a photocatalyst including a core portion containing a photocatalyst excited by light irradiation and a porous layer formed so as to coat the core portion, the core portion containing the photocatalyst is not directly contacted with an organic binder used to fix the photocatalyst and the organic binder does not deteriorate by coating the core portion with the porous layer. Moreover, since the photoactive site of the photocatalyst scarcely decreases by forming a hollow layer between the core portion and the porous layer, photocatalytic ability of the photocatalyst does not decrease. Also, the present inventors have found that when the diameter of the core portion is larger than the diameter of pores of the porous layer, a photocatalytic function can be exerted for a long period without causing outflow of the core portion from the porous layer. Based on these findings, the present invention has been completed.

Thus, the present invention provides a catalyst including: a core portion containing catalyst particles; and a porous layer formed so as to coat the core portion, wherein a hollow layer is formed between the core portion and the porous layer, and the hollow layer is formed by removing a carbon-containing layer formed between the core portion and the porous layer.

In the catalyst with the above constitution, since the hollow layer is formed between the core portion and the porous layer, a solution to be catalyzed penetrates from a porous structure of the porous layer and can be contacted with almost all of catalytic active sites, and thus catalytic activity does not decrease.

Particularly, the catalyst is characterized in that the carbon-containing layer is removed by heating a catalyst including a core portion, a carbon-containing layer formed on the surface of the core portion, and a porous layer formed on the surface of the carbon-containing layer.

The catalyst of the present invention is characterized in that the porous layer contains at least one kind selected from the group consisting of silicon oxide, aluminum oxide, zirconium oxide, magnesium oxide, lanthanum oxide and cerium oxide. These substances are particularly preferred because of their excellent translucency.

The catalyst according to the present invention is characterized in that the catalyst particles are catalyst nano-particles and the catalyst nano-particles contain at least one kind selected from the group consisting of iron (Fe), ruthenium (Ru), cobalt (Co), rhodium (Rh), iridium (Ir), nickel (Ni), palladium (Pd), platinum (Pt), gold (Au), copper (Cu), silver (Ag) and chromium (Cr). High catalytic activity can be obtained by turning catalyst particles into nano-particles. The catalyst is preferred because of their excellent catalytic characteristics.

The catalyst of the present invention is characterized in that the catalyst particles are photocatalysts and the photocatalyst contains at least one kind selected from the group consisting of titanium oxide, strontium titanate, zinc oxide, tungsten oxide, iron oxide, niobium oxide, tantalum oxide, alkali metal titanate and alkali metal niobate. The photocatalyst is preferred since it is excellent in photocatalytic characteristics and can generate a radical having strong oxidizability, and also can satisfactorily remove pollutants through decomposition.

The catalyst according to the present invention is characterized in that the photocatalyst includes at least one metal selected from the group consisting of platinum, rhodium, ruthenium, palladium, silver, copper, nickel and iridium supported thereon. A photocatalytic function can be further improved by supporting the metal on the photocatalyst.

The core portion is substantially spherical and the diameter of the core portion is preferably from 1 nm to 1 μm, more preferably from 1 nm to 100 nm, and still more preferably from 1 nm to 10 nm. The diameter of pores of the porous layer is preferably from 0.1 nm to 100 nm, more preferably from 0.1 nm to 50 nm, and still more preferably from 0.1 nm to 10 nm. Here, it is necessary that the diameter of the core portion is larger than the diameter of pores of the porous layer.

The present invention provides a method for producing a catalyst including a core portion containing catalyst particles and a porous layer formed so as to cover over the core portion, which includes:

a first step of forming a carbon-containing layer so as to coat the core portion; a second step of forming the porous layer so as to coat the carbon-containing layer; and a third step of removing the carbon-containing layer.

According to the method for producing a catalyst of the present invention, the diameter of the core, the thickness of the carbon-containing layer and the diameter of pores of the porous layer can be adjusted to the value which is larger than the diameter of pores. Whereby, outflow of the core portion from the porous layer is prevented, and thus the catalytic function can be exerted for a long period.

In the third step, the carbon-containing layer formed between the core portion and the porous layer is preferably removed by heating the catalyst including the core portion, the carbon-containing layer formed on the surface of the core portion, and the porous layer formed on the surface of the carbon-containing layer.

The method for producing a catalyst of the present invention is characterized in that the catalyst particles are photocatalysts excited by light irradiation.

The porous layer is preferably formed by hydrolysis/dehydration condensation of metal alkoxide, metal acetyl acetate, metal nitrate or metal hydrochloride. This reason is that these substances can easily form a porous structure. The metal alkoxide is particularly preferred since it can form a porous structure at a temperature close to a normal temperature.

The metal alkoxide is preferably at least one kind selected from the group consisting of silicon alkoxide, zirconium alkoxide, aluminum alkoxide, magnesium alkoxide, lanthanum alkoxide and cerium alkoxide.

The carbon-containing layer is preferably formed using, as a raw material, at least one selected from the group consisting of glucose, sucrose, phenol, pyrrole and furfuryl alcohol.

Furthermore, the catalyst according to the present invention is characterized in that it is a catalyst including: a core portion containing photocatalyst particles excited by light irradiation; and a porous layer formed so as to cover over the core portion, wherein a hollow layer is formed between the core portion and the porous layer, the porous layer has translucency, the porous layer has pores which communicate from the outside of the porous layer to the hollow layer, the core portion is substantially spherical, and the diameter of the core portion is larger than the diameter of pores of the porous layer. The porous layer has translucency, whereby, photocatalyst particles can be photoexcited and a photocatalyst having high photocatalytic activity can be obtained. Since the diameter of the core portion is larger than the diameter of pores of the porous layer, the catalytic function can be exerted for a long period without causing outflow of the core portion from the porous layer.

According to the catalyst of the present invention, by forming a hollow layer between the core portion and the porous layer, the active site of the catalyst scarcely decreases and the catalytic function does not deteriorate. When catalyst particles are nano-particles, agglomeration of particles can be prevented, and thus a preferred structure is obtained.

When catalyst particles are photocatalyst particles, since the core portion containing the photocatalyst is not directly contacted with the organic binder used to fix the photocatalyst by covering over the core portion with the porous layer, the organic binder does not deteriorate. For the similar reason, the active site of the photocatalyst scarcely decreases and thus the photocatalytic function does not deteriorate. Furthermore, since the diameter of the core portion is larger than the diameter of pores of the porous layer, the catalytic function can be exerted for a long period without causing outflow of the core portion from the porous layer.

### BRIEF DESCRIPTION OF THE DRAWINGS

FIG. 1 is a schematic sectional view showing the photocatalyst according to the present invention.

FIG. 2 is a schematic perspective view of the photocatalyst according to the present invention drawn excluding a portion of a porous layer.

FIG. 3a is a process drawing showing the method for producing a photocatalyst according to the present invention.

FIG. 3b is a process drawing showing the method for producing a photocatalyst according to the present invention.

FIG. 3c is a process drawing showing the method for producing a photocatalyst according to the present invention.

FIG. 3d is a process drawing showing the method for producing a photocatalyst according to the present invention.

FIG. 4 is a graph showing an initial rate when Pt—SrTiO₃, SiO₂—Pt—SrTiO₃ and p-si//Pt—SrTiO₃ are used.

FIG. 5a is a graph showing a change in an amount of hydrogen and oxygen generated with a lapse of time when w/o-Pt—SrTiO₃ is used.

FIG. 5b is a graph showing a change in an amount of hydrogen and oxygen generated with a lapse of time when w/o-p-si//Pt—SrTiO₃ is used.

FIG. 6 is a graph showing number of moles per-unit of an organic matter modified on the surface of photocatalyst particles before and after light irradiation.

FIG. 7 is a graph showing number of moles per unit of an organic matter modified on the surface of silica of a hollow silica-covered photocatalyst before and after light irradiation.

FIG. 8a is a SEM micrograph showing an anatase type titanium oxide (A-TiO₂).

FIG. 8b is a SEM micrograph showing an anatase type titanium oxide coated with a carbon-layer (c/A-TiO₂).

FIG. 8c is a SEM micrograph showing an anatase type titanium oxide covered with a silica layer via a hollow layer (SiO₂//A-TiO₂).

FIG. 9 is a graph showing an amount of hydrogen generated when methanol is decomposed using an anatase type titanium oxide (A-TiO₂), an anatase type titanium oxide coated with a carbon layer (c/A-TiO₂), and an anatase type titanium oxide covered with a silica layer via a hollow layer (SiO₂//A-TiO₂).

FIG. 10 shows SEM and TEM micrographs of an anatase type titanium oxide covered with a porous layer (silica) via a hollow layer (SiO₂//A-TiO₂) shown in Example 3.

### BRIEF DESCRIPTION OF REFERENCE NUMERALS

1: Core portion, 2: Hollow layer, 2′: Carbon-containing layer, 3: Porous layer

### BEST MODE FOR CARRYING OUT THE INVENTION

The catalyst, particularly a photocatalyst, according to embodiments of the present invention will be described below with reference to the accompanying drawings. It should be understood that these are exemplary of the invention and are not to be considered as limiting. In the present specification, same members are represented by same reference numerals through all drawings.

### Embodiment 1

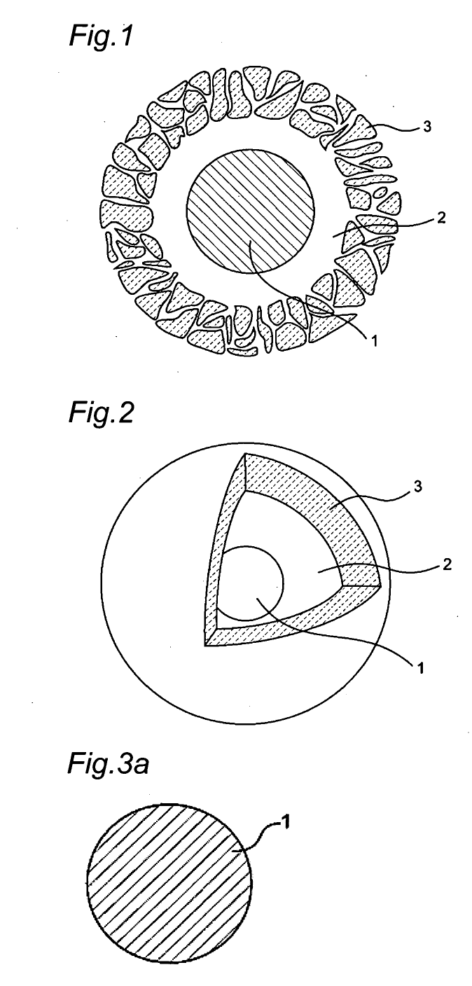

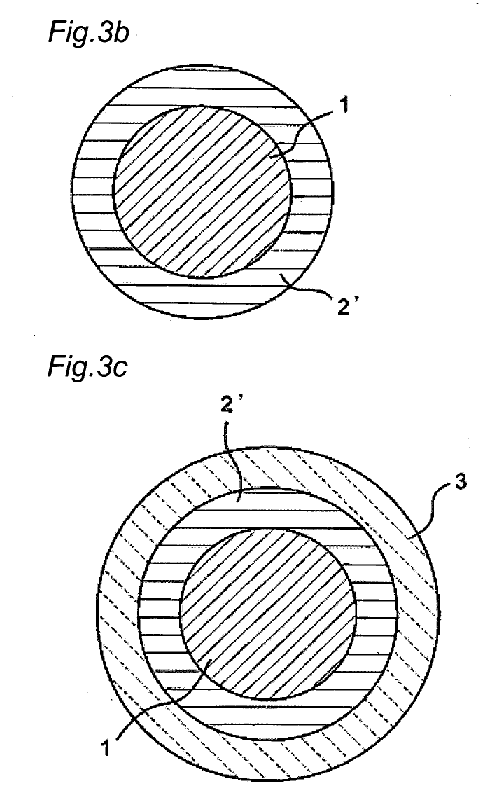

As shown in FIG. 1, the catalyst according to the embodiment of the present invention includes a core portion 1 containing catalyst nano-particles and a porous layer 3 formed so as to cover over the core portion 1, and a hollow layer 2 exists between the core portion 1 and the porous layer 3.

Since the porous layer 3 has a porous structure, a solution to be catalyzed penetrates into the porous layer 3 from the porous structure, where the solution is catalyzed by contacting with the core portion 1 containing the catalyst.

The method for producing a catalyst according to the present invention and the respective elements constituting the catalyst will be described in detail below.

### (Method for Producing Catalyst)

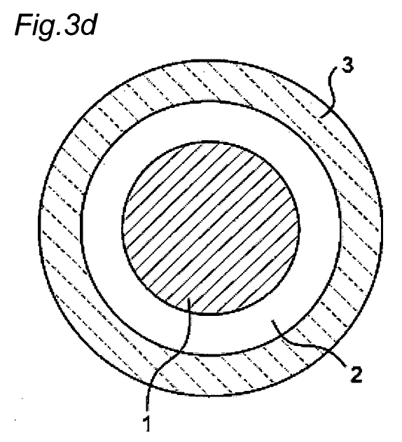

Preferred embodiment of the method for producing a catalyst according to the present invention will be described below with reference to FIG. 3a.

### 1) Preparation of Core Portion 1

A core portion 1 containing a catalyst is prepared (FIG. 3a). A nano-scaled core portion 1 may be formed by turning a bulky metal into nano-scaled ultrafine metal.

### 2) Formation of Carbon-Containing Layer 2′

As shown in FIG. 3b, the core portion 1 is subjected to a hydrothermal treatment in a solution of a carbon-containing organic matter, for example, a glucose solution, thereby coating the surface of the core portion 1 with the carbon-containing organic matter. The core portion 1 coated with the carbon-containing organic matter is carbonized at a high temperature of 500° C. to form a carbon-containing layer 2′ on the surface of the core portion 1.

### 3) Formation of Porous Layer 3

As shown in FIG. 3c, by immersing the core portion 1 coated with the carbon-containing layer 2′ in a substance capable of forming a porous body (for example, a metal alkoxide), a porous layer 3 is formed on the surface of the carbon-containing layer 2′. Here, the porous layer 3 is formed by hydrolysis/dehydration condensation of the metal alkoxide as a precursor of ceramics. Specifically, the core portion 1 coated with the carbon-containing layer 2′ is suspended in a solution containing an alkoxysilane such as tetraethoxysilane (TEOS) and a silicon alkoxide having one or more alkyl groups such as octadecyltrimethoxysilane (ODTS) thereby performing hydrolysis and dehydration condensation reactions of the silicon alkoxide, and thus the surface of the carbon-containing layer 2′ is coated with a SiO₂ layer having an alkyl group. Furthermore, the alkyl group is decomposed by subjecting the product to a heat treatment to form a porous capsule made of a porous SiO₂. The silicon alkoxide capable of forming the porous layer may contain two or more alkyl groups in the molecule, and the alkyl group may be linear or branched, or may contain a functional group at the end or the middle part of the alkyl group. Typical examples of the linear or branched alkyl group include a methyl group, an ethyl group, an n-propyl group, an isopropyl group, an n-butyl group, a sec-butyl group, a tert-butyl group, a pentyl group, an isoamyl group, a hexyl group, an octyl group and an octadecyl group. Typical examples of the functional group include a phenyl group, an amino group, a hydroxyl group, a fluoro group and a thiol group. In the formation of a porous capsule made of a porous SiO₂, only a silicon alkoxide having or more alkyl groups may be heat-treated after hydrolysis/dehydration condensation without adding an alkoxysilane such as tetraethoxysilane (TEOS).

Specific examples of the silicon alkoxide include tetramethoxysilane (TMOS), tetraethoxysilane (TEOS) and tetrabutoxysilane (TBOS).

When the silicon alkoxide having the functional group such as an alkyl group is used, hydrolysis and dehydration condensation reactions proceed while the functional group is remained. An example of hydrolysis and dehydration condensation reactions of ODTS (octadecyltrimethoxysilane, Si(OCH₃)₃(C₁₈H₃₇)) will be shown below.

### 1. Hydrolysis Reaction

Si(OCH₃)₃(C₁₈H₃₇)+3H₂O→Si(OH)₃(C₁₈H₃₇)+3CH₃OH

### 2. Dehydration Condensation Reaction

Si(OH)₃(C₁₈H₃₇)+Si (OH)₃(C₁₈H₃₇)→(C₁₈H₃₇)(OH)₂Si—O—Si(OH)₂(C₁₈H₃₇)+H₂O

SiO₂ having an octadecyl group (C₁₈H₃₇—) formed by the reaction is turned into a porous SiO₂ since the moiety of the octadecyl group is removed by decomposition with heating to form pores of the porous layer.

### 4) Removal of Carbon-Containing Layer 2′

As shown in FIG. 3d, by heating the catalyst with the porous layer 3 formed thereon, the carbon-containing layer 2′ formed between the porous layer 3 and the core portion 1 is removed. The removed portion is referred to as a hollow layer 2.

### 5) Activation Treatment

When the core portion 1 contains metal nano-particles, a reduction treatment is optionally conducted by a heat treatment under a hydrogen atmosphere to obtain the catalyst according to the present invention.

While the carbon-containing layer is used so as to form the hollow layer 2 in the above-described method, a polymer layer may be used in place of the carbon-containing layer. The carbon-containing layer may be a carbon layer.

The method is not limited to the above-described method, and the catalyst according to the present invention may be produced by any method.

### (Catalyst Nano-Particles)

In the catalyst of the present invention, catalyst particles contained in the core portion 1 are preferably nano-particles. The catalyst particles contain at least one kind selected from the group consisting of iron (Fe), ruthenium (Ru), cobalt (Co), rhodium (Rh), iridium (Ir), nickel (Ni), palladium (Pd), platinum (Pt), gold (Au), copper (Cu), silver (Ag) and chromium (Cr). However, the catalyst particles are not limited to these catalyst particles and may contain any substance as long as it exerts a catalytic action. The catalyst particles may have various forms such as a simple substance, an alloy and an inorganic salt.

### (Core Portion)

From a manufacturing point of view, it is preferred that the core portion 1 is substantially spherical. However, the core portion may have any shape as long as the catalytic function can be satisfactorily exerted. When the core portion 1 is substantially spherical, the diameter is preferably within a range from 1 nm to 1 μm, more preferably from 1 nm to 100 nm, and still more preferably from 1 nm to 10 nm.

The core portion 1 may partially contain catalyst particles. For example, the core portion 1 may contain catalyst particles at the surface layer portion. However, the entire core portion is preferably composed of catalyst particles. As described above, when the entire core portion is preferably composed of catalyst particles, the active site of the catalyst can be effectively utilized.

Here, the core portion 1 is integrally formed and one of them is enclosed in the porous layer 3, and a plurality of core portions 1 may exist in the porous layer 3.

The core portion 1 may be hollow. Furthermore, the core portion 1 may partially have a porous structure, fine catalyst particles being dispersed in pores of the porous structure.

### (Porous Layer (Porous Capsule))

The core portion 1 containing catalyst particles is covered with the porous layer 3 via the hollow layer. Agglomeration of catalyst particles can be prevented by covering the catalyst particles via the hollow layer.

The porous layer 3 is hollow and partially contains a porous structure at the surface layer portion of the outer surface and the inner surface of the porous layer 3. The porous structure partially contains pores which communicate from the outside of the porous layer 3 to the hollow layer 2.

The shape of the porous layer 3 is not limited to a spherical shape and may be any shape as long as the same effects described above can be exerted. However, from a manufacturing point of view, the shape is preferably substantially spherical shape.

The diameter of the porous layer 3 is preferably from 50 nm to 5 μm. The diameter is within the above range since the catalysts can be easily recovered.

Furthermore, porosity and the diameter of pores of the porous layer 3 are not specifically limited as long as they enable pollutants, odors, polluted water and microorganisms to pass from the outside of the porous layer 3, and do not cause outflow of the core portion 1. The porosity of the porous layer 3 is preferably from 10 vol % to 90 vol %, more preferably from 20 vol % to 80 vol %, and still more preferably from 30 vol % to 70 vol %. The pore diameter of the porous structure of the porous layer 3 is preferably from 0.1 nm to 100 nm, more preferably from 0.1 nm to 50 nm, and still more preferably from 0.1 nm to 10 nm. —Similar to the above case, the thickness of the porous layer 3 is not specifically limited as long as it enables pollutants, odors, polluted water and microorganisms to pass from the outside of the porous layer 3 and ultraviolet light to reach the core portion 1, and also the porous layer 3 itself has durability. Taking account of the above conditions, the thickness of the porous layer 3 is preferably within a range from 10 nm to 1 μm.

The porous layer 3 may be made of any raw material as long as it can form a porous (oxide) structure. Examples of the raw material capable of satisfactorily forming the porous structure include metal alkoxide, metal acetyl acetate, metal nitrate and metal hydrochloride.

Specific examples of preferred metal alkoxide include silicon alkoxide, zirconium alkoxide, aluminum alkoxide, magnesium alkoxide, lanthanum alkoxide and cerium alkoxide. Specific examples of preferred metal acetyl acetate include zirconium acetyl acetate, magnesium acetyl acetate and cerium acetyl acetate. Specific examples of more preferred metal nitrate include lanthanum nitrate and cerium nitrate, and specific examples of preferred metal hydrochloride include zirconium chloride, magnesium chloride and cerium chloride. These metal alkoxides are preferred because of excellent translucency.

The porous layer 3 is composed of a single-layered layer and the layer may be formed of two or more different materials. The porous layer 3 may be composed of two or more layers and each layer may be formed of one kind of a material, or formed of two or more different materials.

### (Hollow Layer)

The thickness of the hollow layer 2 is defined as a minimum distance between the inner surface of the porous layer 3 and the outer surface of the core portion 1 when an arrangement thereof is made so as to make center of gravity of the porous layer 3 to agree with center of gravity of the core portion 1. The thickness of the hollow layer 2 is preferably within a range from 1 nm to 100 nm.

### Embodiment 2

Subsequently, the catalyst according to Embodiment 2 of the present invention will be described below. Embodiment 2 is different from Embodiment 1 in that photocatalyst particles are used as catalyst particles.

The catalyst according to the present invention includes a core portion 1 containing a photocatalyst excited by light irradiation and a porous layer 3 formed so as to cover over the core portion 1, and a hollow layer 2 is formed between the core portion 1 and the porous layer 3.

Since the porous layer 3 has a porous structure, when substances such as toxic substances and odors penetrate into the porous layer 3 and these substances are irradiated with ultraviolet light in a state of contacting with the core portion 1 containing the photocatalysts, the photocatalysts are photoexcited to form electrons and holes and thus pollutants and odors in the vicinity of the surface of the photocatalyst are decomposed by a radical generated by charges.

The photocatalysts are usually mixed with an organic binder when used so as to coat the wall surface of tile with the photocatalyst. In the photocatalyst according to the present invention, the organic binder does not directly contact with the core portion 1 containing photocatalyst particles. Therefore, the organic binder is not deteriorated by a photocatalytic action.

The respective elements constituting the photocatalyst of the present invention will be described in detail below. However, descriptions of elements having the same constitution as that of Embodiment 1 are omitted.

### (Photocatalyst)

The photocatalyst is mainly contained in the core portion 1, and may be contained in the porous layer 3. The substance serving as the photocatalyst may be any one. Specific examples of the photocatalyst include titanium oxide, strontium titanate, zinc oxide, tungsten oxide, iron oxide, niobium oxide, tantalum oxide, alkali metal titanate and alkali metal niobate. The photocatalyst may contain two or more kinds of these substances.

In view of the photocatalytic action, titanium oxide and strontium titanate are preferably used. Here, when titanium oxide is used as the photocatalyst, the titanium oxide may be amorphous, rutile type or anatase type titanium oxide. However, an anatase type titanium oxide is preferred because of high photocatalytic activity.

### (Core Portion)

The core portion 1 may partially contain photocatalyst particles. For example, the core portion 1 may contain photocatalyst particles at the surface layer portion. The entire core portion is preferably composed of photocatalyst particles. As described above, when the entire core portion is composed of photocatalyst particles, the active site of the photocatalyst can be effectively utilized.

When catalyst particles are photocatalysts, the diameter of the core portion is preferably within a range from 10 nm to 10 μm, more preferably from 10 nm to 1 μm, and still more preferably from 10 nm to 100 nm. When the diameter of the core portion is within the above range, the diameter of the porous layer 3 is preferably within a range from 50 nm to 50 μm.

Since the diameter of the core portion 1 is larger than the diameter of pores of the porous layer 3, the photocatalyst according to the present invention is different from a photocatalyst in which fine photocatalyst particles are dispersed in a porous portion of a porous silica (Japanese Unexamined Patent Publication (Kokai) No. 2001-286728).

In the photocatalyst in which fine photocatalyst particles are dispersed in a porous portion of a porous silica (Japanese Unexamined Patent Publication (Kokai) No. 2001-286728), since fine photocatalyst particles are dispersed in the porous silica, fine photocatalyst particles fall off with a lapse of time and thus a photocatalytic function deteriorates when used for a long period. It cannot be said that all photocatalyst particles are applied for a photocatalytic action since a large amount of fine photocatalyst particles exist inside other than the surface of the porous substance. However, in the catalyst of the present invention, all photocatalyst particles can be applied for the photocatalytic action. The photocatalyst of the present invention can exert a photocatalytic function for a long period without causing outflow of a core portion 1 from a porous layer 3 since the diameter of the core portion 1 is larger than the diameter of pores of the porous layer 3.

Furthermore, the core portion 1 may partially have a porous structure, fine photocatalyst particles being dispersed in pores of the porous structure. When the core portion 1 includes a porous structure, pollutants can be adsorbed on the porous structure while light is not irradiated, and pollutants adsorbed on the porous structure can be decomposed.

### Example 1

The catalyst according to Example 1 will be described in detail below. In Example 1, strontium titanate (SrTiO₃) was used as photocatalyst particles contained in the core portion 1.

First, platinum was supported on strontium titanate (SrTiO₃) manufactured by FUJI TITANIUM INDUSTRY CO., LTD. using a photoelectrodeposition method to obtain Pt-supported strontium titanate (hereinafter referred to as Pt—SrTiO₃, “Pt—” as used herein means to support Pt). Pt—SrTiO₃ suspended in an aqueous glucose solution was subjected to a hydrothermal treatment at 180° C. to obtain carbon-coated Pt—SrTiO₃ (hereinafter referred to as c/Pt—SrTiO₃, “c/” as used herein means to coat with carbon). The carbon-coated Pt—SrTiO₃ thus obtained was reacted with tetraethoxysilane (TEOS) thereby coating the surface with silica (referred to as si/c/Pt—SrTiO₃, “si/c/” as used herein means that a silica layer is formed on a carbon layer after forming the carbon layer), and then carbon was removed by subjecting to a heat treatment in the air (600° C.) to obtain silica-covered Pt—SrTiO₃ (referred to as p-si//Pt—SrTiO₃, p-si as used herein means porous Si, and “//” means that a hollow layer exists between p-si and Pt—SrTiO₃). As Comparative Example, a sample (si/Pt—SrTiO₃) obtained by directly coating the surface of a core portion with silica without coating with carbon was used. After adding a predetermined amount of water, each photocatalyst was suspended in a tridecafluoroethyltrimethoxysilane (DFMS)/toluene solution, centrifuged and then dried to obtain amphipathic Pt—SrTiO₃ in which a portion of the surface is modified with a hydrophobic group (w/o-Pt—SrTiO₃, w/o-p-si//Pt—SrTiO₃, w/o-si/Pt—SrTiO₃, “w/o-” as used herein means that a portion of the surface is modified with a hydrophobic group). Pt—SrTiO₃ was suspended in a DFMS solution without using water to prepare hydrophobic Pt—SrTiO₃ whose entire surface is modified (hereinafter referred to as o-Pt—SrTiO₃, “o-” as used herein means that the entire surface is modified with a hydrophobic group). The hydrolysis reaction was conducted using a closed circulation system. In a cylindrical Pyrex® reaction cell (diameter: 7 cm, volume: 350 ml), 150 ml of water and 50 mg of a photocatalyst were charged, followed by irradiation with light from the top or side face of the reaction cell under argon (4 kPa). As a light source, a 500 W ultrahigh pressure mercury lamp was used. Identification and quantitative determination of the gas produced were conducted using a gas chromatograph connected directly to the system.

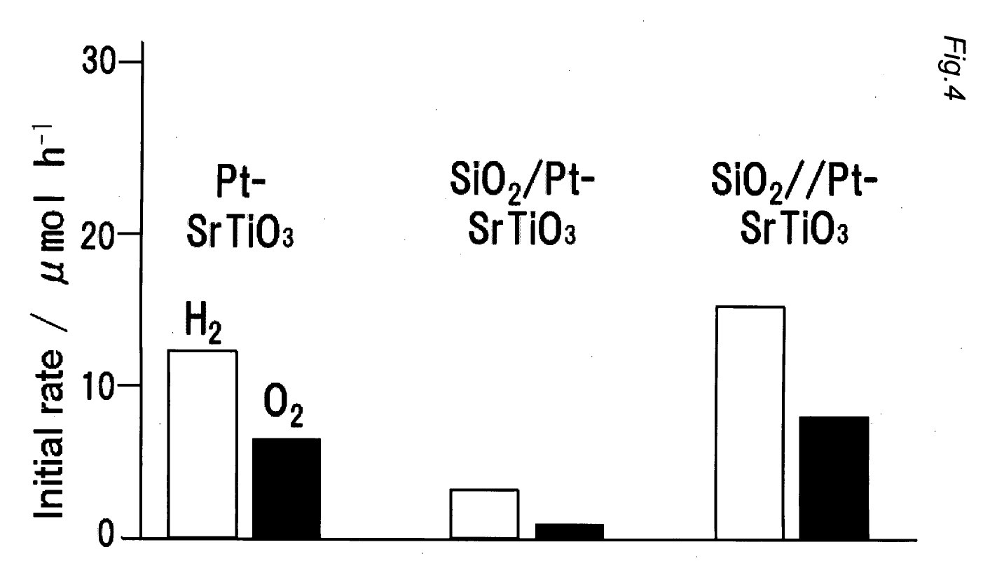

Even if c/Pt—SrTiO₃, si/c/Pt—SrTiO₃ and si/Pt—SrTiO₃ were suspended in water and irradiated with light from the upper side, they scarcely showed activity. The reason is considered that the active site of the surface of the photocatalyst is coated with carbon or silica. In contrast, p-si//Pt—SrTiO₃ showed nearly the same activity as in case of non-coated Pt—SrTiO₃, although silica exists on the surface (FIG. 4). It is considered that when covered with porous silica in a hollow shape (p-si//Pt—SrTiO₃), hollow cavities exist between silica and Pt—SrTiO₃ and the active site can be sufficiently utilized, and thus the photocatalyst showed activity.

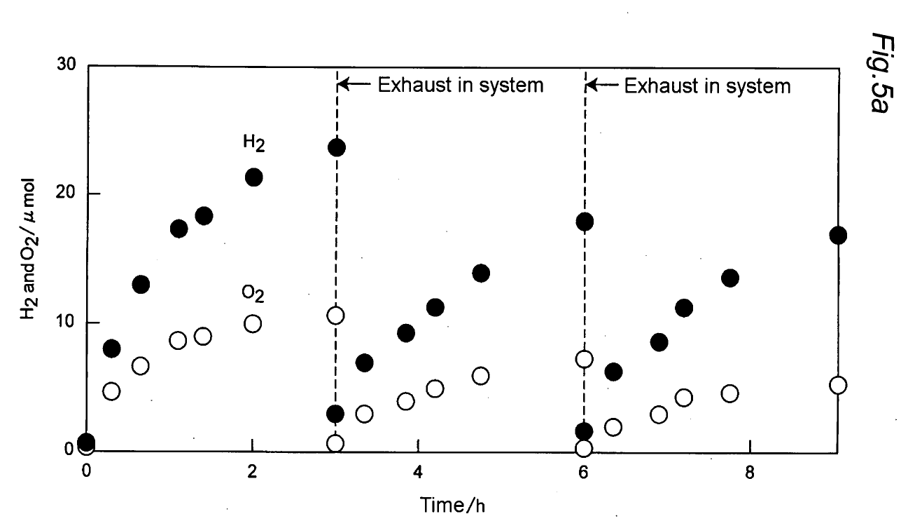

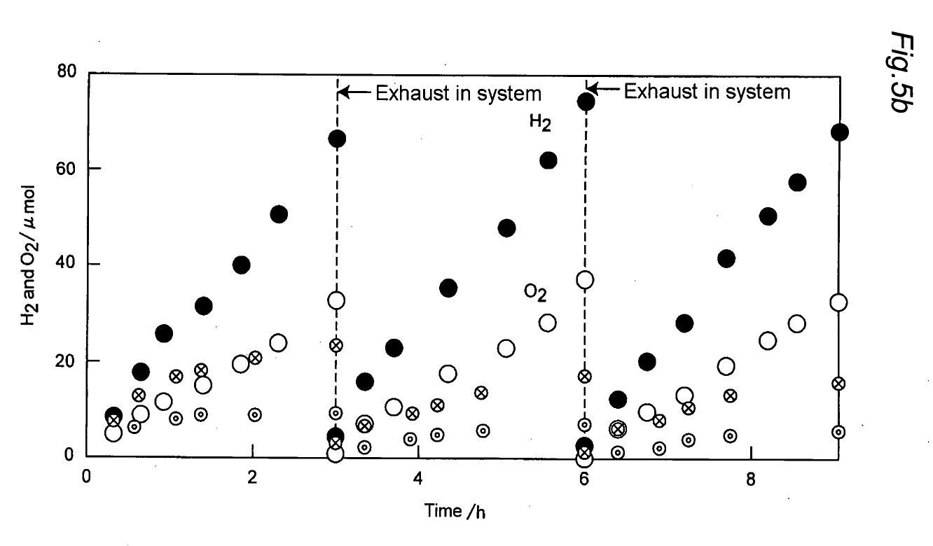

An initial rate of hydrogen and oxygen generated by photodecomposition of water when w/o-Pt—SrTiO₃ is irradiated with light from the upper side while floating on water (FIG. 5a), and when w/o-p-si//Pt—SrTiO₃ is similarly irradiated with light from the upper side while floating on water (FIG. 5b) is shown in FIG. 4. When w/o-Pt—SrTiO₃ is irradiated with light from the upper side while floating on water, w/o-Pt—SrTiO₃ particles existing on an interface gradually sunk in water as it is irradiated with light, and thus activity decreased (FIG. 5a). The sample irradiated with light for 12 hours was recovered and the amount of the surface hydrophobic group existing in the same was estimated. As a result, the amount of the surface hydrophobic group decreased to about half of the sample before irradiation with light as shown in FIG. 6. These results suggest that decomposition of the hydrophobic group arises.

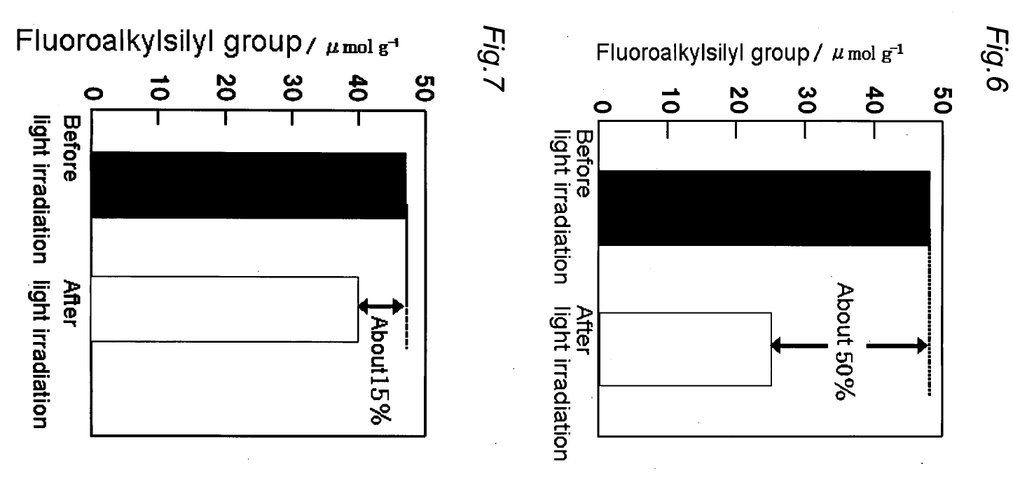

A change with a lapse of time in case that w/o-p-si//Pt—SrTiO₃ is similarly irradiated with light is shown in FIG. 5b. In this case, the photocatalysts scarcely sunk in water and activity did not decrease. The reason is considered that the sample functioned as a stable photocatalyst since decomposition of the hydrophobic group was suppressed by silica on the surface (FIG. 7) and the active site can be effectively utilized by the existence of cavities described above. Therefore, it was found that even if the photocatalyst is mixed with the organic binder when used, photocatalytic activity of photocatalyst particles did not decrease and decomposition of the organic binder does not arise.

### Example 2

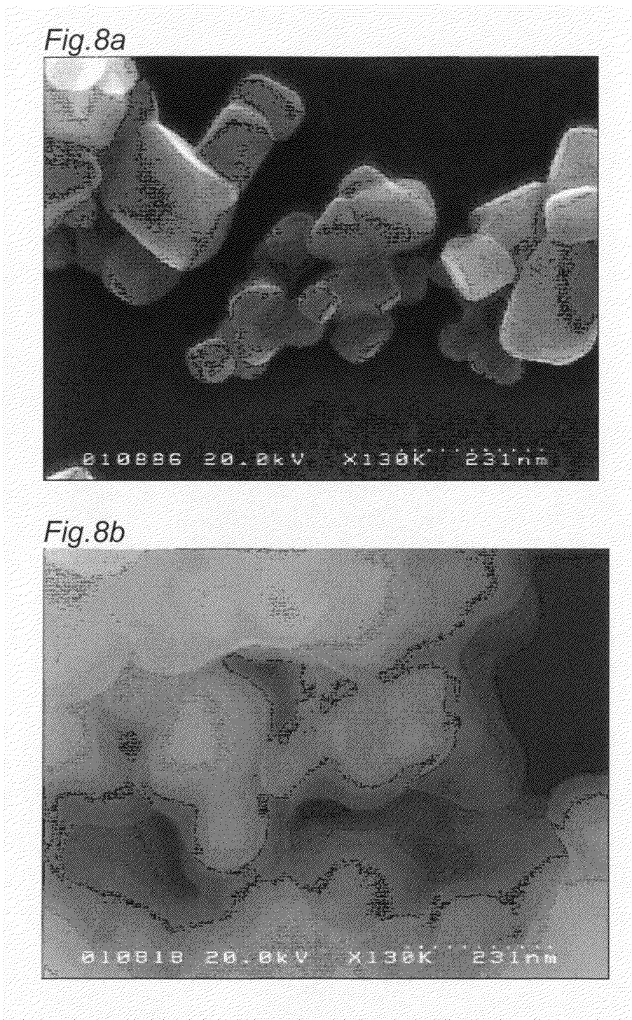

In Example 2, an anatase type titanium oxide (A-TiO₂) was used as photocatalyst particles contained in a core portion. FIG. 8a shows an anatase type titanium oxide (A-TiO₂), FIG. 8b shows an anatase type titanium oxide coated with a carbon layer (c/A-TiO₂), and FIG. 8c shows an anatase type titanium oxide covered with a silica layer via a hollow layer (SiO₂//A-TiO₂).

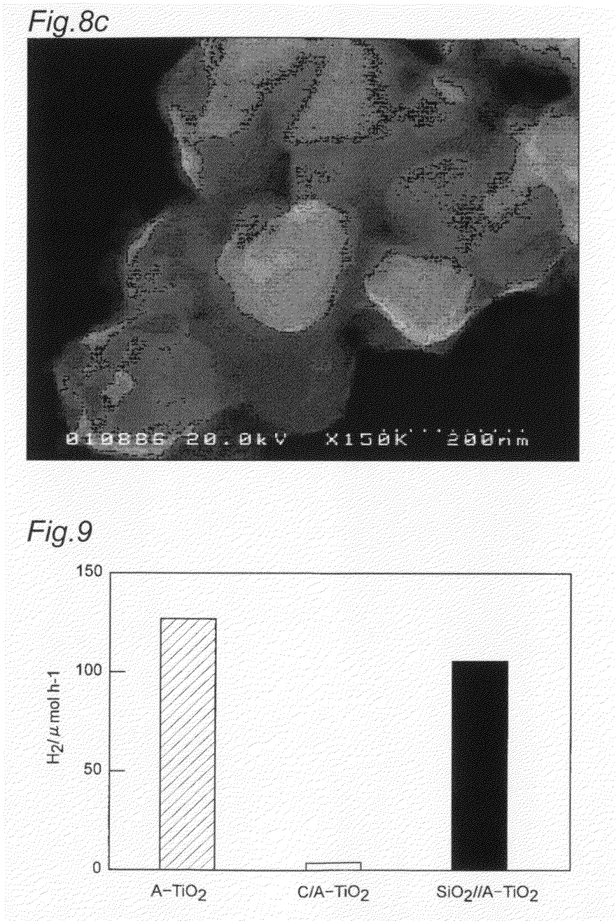

The anatase type titanium oxides (A-TiO₂) shown in FIG. 58a to 8c were irradiated with ultraviolet light of 290 nm thereby decomposing methanol. The decomposition reaction was conducted under an argon atmosphere. The amount of hydrogen generated by decomposition of methanol was determined by gas chromatography. The results are shown in FIG. 9. As shown in FIG. 9, hydrogen was scarcely generated in the anatase type titanium oxide (c/A-TiO₂) coated with the carbon layer. The reason is considered that the active site of the surface of the photocatalyst is coated with carbon similarly to the case of Example 1. In the case of the anatase type titanium oxide (SiO₂//A-TiO₂) covered with the silica layer via the hollow layer shown in FIG. 8c, the amount of hydrogen generated did not drastically decrease as compared with the non-coated anatase type titanium oxide (A-TiO₂) shown in FIG. 8a.

Even if the anatase type titanium oxide is used, photocatalytic activity of photocatalyst particles did not decrease. It is considered that hollow cavities exist between silica and A-TiO₂ and the active site can be sufficiently utilized.

### Example 3

In Example 3, an anatase type titanium oxide (A-TiO₂) was used as photocatalyst particles contained in the core portion.

1. Preparation of APS-A-TiO₂ (APS-A-TiO₂ as Used Herein Means TiO₂ Modified with Aminopropyltrimethoxysilane) Modified with Aminopropyltrimethoxysilane (APS)

First, 0.5 g of titanium oxide (manufactured by ISHIHARA SANGYO KAISHA, LTD. ST-41) was weighed in a sample tube and 10 ml of methanol and 0.1 ml of APS were added, followed by dispersion with supersonic wave and further stirring for one hour. The solution was centrifuged and the supernatant was removed, and then the precipitate was washed four times with ethanol. After washing, the precipitate was vacuum-dried at 383 K for 2 hours.

2. Preparation of c/APS-A-TiO₂ by Coating APS-A-TiO₂ with Carbon

APS-A-TiO₂ (0.2 g) was added to 80 ml of an aqueous 0.5M glucose solution and dispersed with supersonic wave. The resultant solution was charged in a Teflon® container for hydrothermal synthesis, and then hydrothermal synthesis was conducted in a hydrothermal synthesis apparatus at 453 K for 6 hours while rotating a synthesis container at 15 rpm.

After the completion of the hydrothermal synthesis, a catalyst was recovered by suction filtration, the product was washed with ethanol and pure water, and then vacuum-dried at 383 K for 2 hours. 0.2 g of the recovered c/APS-A-TiO₂ was heated to 823 K at a heating rate of 10 K/min under vacuum and then fired for 2 hours.

c/APS-A-TiO₂ (0.3 g) was immersed in an aqueous 10% hydrogen fluoride solution (6 ml) for one hour so as to remove modified APS. After the catalyst was recovered by filtration, the product was washed with pure water and then vacuum-dried at 383 K for 2 hours.

3. Preparation of SiO₂/c/A-TiO₂ by Coating c/A-TiO₂ with Silica

c/A-TiO₂ (0.2 g) was weighed in a sample tube and 6 ml of methanol and 0.13 ml of 3-(2-aminoethylaminopropyl)triethoxysilane (AEAP) were added, followed by dispersion with supersonic wave and further stirring for 1.5 hours. The solution was centrifuged and the supernatant was removed, and then the precipitate was washed four times with ethanol. To the resultant precipitate (about 0.2 g), 14.8 ml of ethanol, 0.44 ml of an aqueous 28 wt % ammonia solution and 2 ml of pure water were added. After dispersing through supersonic wave, 1.6 ml of tetraethoxysilane (TEOS) was added, followed by shaking at 128 rpm for one hour. After shaking, a catalyst was recovered and the product was vacuum-dried at 383 K for 2 hours. After washing, the product was vacuum-dried at 383K for 2 hours. It is considered that a hydroxyl group is built on the surface of carbon via an amino group by treating with AEAP, whereby, following decomposition and condensation reactions of TEOS selectively occur on the surface of carbon and thus the surface is satisfactorily coated.

### 4. Preparation of SiO₂//A-TiO₂ by Removing Carbon Film

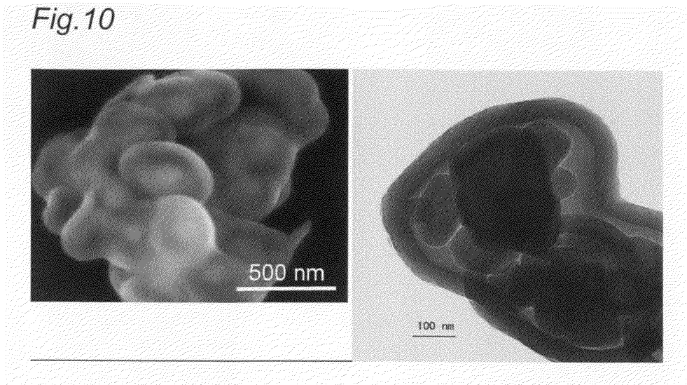

0.2 g of SiO₂/c/A-TiO₂ was heated to 823 K at a heating rate of 10 K/min under vacuum and then fired for 2 hours. Subsequently, the vacuum-fired catalyst was heated to 873 K at a heating rate of 10 K/min in the air and then fired for 3 hours to produce a photocatalyst included in a porous capsule (porous layer). FIG. 10 shows a SEM micrograph (left side) and a TEM micrograph (right side) of SiO₂//A-TiO₂.

### 5. Test on Selective Permeability of Capsule

Subsequently, using the photocatalyst thus obtained, various organic matters described below were decomposed by the photocatalyst reaction and a difference in a reacting weight between the case where a capsule is present and the case where a capsule is absent was measured. In this test, CH₃COOH, CH₃OH, isopropanol and polyvinyl alcohol were used as the organic matter.

As shown in FIG. 1, when CH₃COOH is used as a reactant, an aqueous 5% CH₃COOH solution was oxidatively decomposed in the air and CO₂ generated was detected. When CH₃OH is used as a reactant, an aqueous 50% CH₃OH solution was dehydrogenated in Ar and H₂ generated was detected. Furthermore, when isopropanol is used, the vapor phase reaction was conducted in the air and an amount of isopropanol decreased was measured. Also, when polyvinyl alcohol is used, an aqueous polyvinyl alcohol solution was oxidatively decomposed in the air and CO₂ generated was detected.

TABLE 1

| | Substance | | | Rate of production using | |
|---|---|---|---|---|---|
| | used in | | Rate of production | A-TiO₂ (ST-41) included | |
| Reactant | detection | Reaction conditions | using A-TiO₂ (ST-41) | in porous capsule | |
| CH₃COOH | CO₂ | Oxidative decomposition of | 21 μmol · h⁻¹ | 21 | μmol · h⁻¹ |
| | (Product) | aqueous 5% solution in air | | | |
| CH₃OH | H₂ | Dehydrogenation reaction of | 330 μmol · h⁻¹ | 340 | μmol · h⁻¹ |
| | (Product) | aqueous 50% solution in Ar | | | |
| Isopropanol | Isopropanol | Vapor phase reaction in air | * (k=) 2.9 × 10⁻³ min⁻¹ | * (k=) 2.6 × 10⁻³ min⁻¹ | |
| | (Decrease) | | | | |
| Polyvinyl | CO₂ | Oxidative decomposition of | 10 μmol · h⁻¹ | 3 | μmol · h⁻¹ |
| alcohol | (Product) | aqueous solution in air | | | |

The symbol * denotes a primary reaction rate constant, and others denote a production rate.

When CH₃COOH, CH₃OH and isopropanol, each having a small molecular size, are used as the reactant, the amounts of these organic matters decomposed were nearly the same whether the photocatalyst is coated with the porous capsule or not. It is considered that the porous capsule does not serve as a limiting element of the decomposition reaction to these organic matters having a small molecular size, and these organic matters passed through pores of the capsule and were decomposed by A-TiO₂ in the capsule.

In contrast, when polyvinyl alcohol having a large molecular size as the reactant, the amount of the organic matter decomposed remarkably decreases if the photocatalyst is coated with the porous capsule as compared with the case where the photocatalyst is not coated with the porous capsule. The amount of the organic matter decomposed was one-third or less of the amount of the organic matter decomposed in the case where the catalyst is not coated with the porous capsule. Thus, it is considered that since some of the organic matters having a large molecular size cannot pass through pores of the porous capsule, the amount of the organic matter decomposed decreases.

Therefore, by using the photocatalyst included in the porous capsule of the present invention, when the photocatalyst is mixed with a binder and the wall portion of the house structure is coated with the resultant mixture thereby removing dirt and discoloration of the wall portion, the binder composed of an organic matter having comparatively large molecular size is not decomposed and deteriorated by the photocatalyst, and also it is possible to decompose only an organic matter having a small molecular size which is a causative of dirt and discoloration. Moreover, since a hollow portion is formed between the photocatalyst and the capsule in the case of the organic matter having a small molecular size, the active site does not decrease and the photocatalyst has nearly the same oxidizability as that in the case where the capsule is not used. Therefore, the photocatalyst included in the porous capsule of the present invention can be preferably used when the photocatalyst is mixed with the binder and the wall portion of the house structure is coated with the resultant mixture.

### INDUSTRIAL APPLICABILITY

The photocatalyst of the present invention can exert a photocatalytic function for a long period without causing outflow of a core portion from a porous layer since the diameter of the core portion is larger than the diameter of pores of the porous layer. Therefore, the photocatalyst of the present invention is particularly useful as a substance to be coated on the wall surface of the house structure, which must maintain a decomposition function for a long period.

1-15. (canceled)

16. A catalyst comprising:
a core portion containing catalyst particles; and
a porous layer formed so as to cover over the core portion,
wherein a hollow layer is formed between the core portion and the porous layer, and
wherein the catalyst particles are catalyst comprising at least one kind selected from the group consisting of iron (Fe), ruthenium (Ru), cobalt (Co), rhodium (Rh), iridium (Ir), nickel (Ni), palladium (Pd), platinum (Pt), gold (Au), copper (Cu), silver (Ag) and chromium (Cr) or photocatalyst comprising at least one kind selected from the group consisting of titanium oxide, strontium titanate, zinc oxide, tungsten oxide, iron oxide, niobium oxide, tantalum oxide, alkali metal titanate and alkali metal niobate.

17. The catalyst according to claim 16, wherein the porous layer contains at least one kind selected from the group consisting of silicon oxide, aluminum oxide, zirconium oxide, magnesium oxide, lanthanum oxide and cerium oxide.

18. The catalyst according to claim 16, wherein the photocatalyst includes at least one metal selected from the group consisting of platinum, rhodium, ruthenium, palladium, silver, copper, nickel and iridium supported thereon.

19. A method for producing a catalyst comprising a core portion containing catalyst particles and a porous layer formed so as to cover over the core portion, which comprises:
a first step of forming an intermediate layer so as to coat the core portion;
a second step of forming the porous layer so as to coat the intermediate layer; and
a third step of removing the intermediate layer.

20. The method according to claim 19, wherein in the third step, the intermediate layer formed between the core portion and the porous layer is removed by heating the catalyst.

21. The method according to claim 19, wherein the catalyst particles are photocatalysts excited by light irradiation.

22. The method according to claim 19, wherein the porous layer is formed by hydrolysis/dehydration condensation of metal alkoxide, metal acetyl acetate, metal nitrate or metal hydrochloride.

23. The method according to claim 22, wherein the metal alkoxide is at least one kind selected from the group consisting of silicon alkoxide, zirconium alkoxide, aluminum alkoxide, magnesium alkoxide, lanthanum alkoxide and cerium alkoxide.

24. The method according to claim 19, wherein the intermediate layer is formed using, as a raw material, at least one selected from the group consisting of glucose, sucrose, phenol, pyrrole and furfuryl alcohol.

25. A catalyst comprising:
a core portion containing photocatalyst particles excited by light irradiation; and
a porous layer formed so as to cover over the core portion,
wherein a hollow layer is formed between the core portion and the porous layer, the photocatalyst particles comprise at least one kind selected from the group consisting of titanium oxide, strontium titanate, zinc oxide, tungsten oxide, iron oxide, niobium oxide, tantalum oxide, alkali metal titanate and alkali metal niobate, the porous layer has translucency, the porous layer has pores which communicate from the outside of the porous layer to the hollow layer, the core portion is substantially spherical, and the diameter of the core portion is larger than the diameter of pores of the porous layer.
